(19) United States
(12) Patent Application Publication
(10) Pub. No.: US 2002/0032861 A1
(43) Pub. Date: Mar. 14, 2002

(54) System and method for executing and assuring security of electronic mail for users, and storage medium storing program to cause computer to implement same method

(75) Inventor: Tomihiko Azuma, Tokyo (JP)

Correspondence Address: Paul-J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/906,347

(22) Filed: Jul. 16, 2001

(30) Foreign Application Priority Data
Jul. 14, 2000 (JP) 214624/2000

(51) Int. Cl. H04L 9/00; G06F 15/167

(52) U.S. Cl. 713/170; 713/200; 709/206

(57) ABSTRACT

A system and method are provided which are capable of assuring security of electronic mail in the Internet regardless of whether security functions are implemented on a side of a client such as a user terminal or a like.

An internet service provider that provides service to connect the user terminal to the Internet has units executing, for users, necessary processing required for assuring security including: encryption of electronic mail transmitted from the user terminal to the Internet, affixing of a signature to the electronic mail, checking on tampering of encrypted mail with signatures transmitted from the Internet, and decryption of the encrypted mail or a like.

### BACKGROUND OF THE INVENTION

1. Field of the Invention

The present invention relates to a system and a method for executing and assuring security of electronic mail for users, and storage medium storing program to cause computer to implement the same method.

The present application claims priority of Japanese Patent ApplicationNo.2000-214624 filed on Jul. 14, 2000, which is hereby incorporated by reference.

2. Description of the Related Art

As a system for assuring security of an electronic mail, a mail client is widely used which has a security function including S/MIME (Secure/Multipurpose Internet Mail Extension), developed by RSA Data Security Corporation, in which an encrypted message is transmitted in a form of “MIME”, PGP (Pretty Good Privacy) being an encrypting program developed by PGP Corporation, in which contents of an electronic mail encrypted using a public key of a mail receiver of the electronic mail are transmitted.

To operate such security functions effectively, a method is generally employed in which a private key of a mail transmitter or a digital certificate of the mail receiver or a like is installed on a user terminal used by the mail transmitter.

However, such a conventional system and method have the following problems. That is, since kinds of terminals are widely expanding from a conventional PC (Personal Computer) into various types of terminals including a portable cellar phone, a personal digital assistant, a FAX (Facsimile) and, at a same time, terminals having no mail clients provided with security functions increase, it is becoming impossible to assure security of electronic mail on the Internet.

In a portable cellular phone which is now becoming widespread rapidly, it is difficult for its terminal to implement a security function, thus causing interference with use in businesses.

### SUMMARY OF THE INVENTION

In view of the above, it is an object of the present invention to provide a system and a method which are capable of assuring security of an electronic mail in the Internet, regardless of whether a security function is implemented on a side of a client such as a user terminal and a storage medium storing programs to control the same.

According to a first aspect of the present invention, there is provided a system executing and assuring security of electronic mail for users, including:

an internet service provider that provides service to connect a user terminal to the Internet and executes for the users processing required for security management having encryption of electronic mail to be transmitted from the user terminal to the Internet, affixing of signatures to the electronic mail, checking on tampering of and decryption of the encrypted electronic mail with the signatures transmitted from the Internet.

According to a second aspect of the present invention, there is provided a system executing and assuring security of electronic mail for users, including:

an internet service provider that provides service to connect a user terminal to the Internet and that has,

a unit to encrypt electronic mail received from the user terminal, to affix a signature to the electronic mail and to transmit the encrypted electronic mail with the signature to the Internet;

a unit to check whether the encrypted electronic mail has been tampered or not when the encrypted electronic mail with the signature is transmitted from the Internet and to decrypt the encrypted electronic mail when the encrypted electronic mail has not been tampered; and

whereby security of electronic mail in the Internet is able to be assured regardless of types of the user terminal or regardless of whether security functions are implemented or not on a side of the user terminal.

According to a third aspect of the present invention, there is provided a system executing and assuring security of electronic mail for users, including:

an internet service provider that provides service to connect a user terminal to the Internet and that has,

a unit to encrypt clear text electronic mail received from the user terminal so that only an electronic mail receiver is allowed to decrypt the encrypted electronic mail;

a unit to affix a signature of an electronic mail transmitter to the encrypted electronic mail and to transmit the encrypted electronic mail with the signature to the Internet;

a unit to check, when the encrypted electronic mail with the signature addressed to the user terminal is received through the Internet, whether the encrypted electronic mail with the signature has been tampered or not;

a unit to decrypt the encrypted electronic mail, when the encrypted electronic mail has not been tampered, to produce the clear text electronic mail;

a unit to distribute the produced clear text electronic mail to the user terminal when a request for receiving electronic mail is made by the user terminal; and

wherein, if the encrypted electronic mail has been tampered, the encrypted electronic mail is discarded.

According to a fourth aspect of the present invention, there is provided a server of an internet service provider that provides service to connect a user terminal to the Internet, including:

a storage device having a private key storing unit to store a pair of pieces of information about an electronic mail address and a private key corresponding to the electronic mail address and a public key storing unit to store a pair of pieces of information about an electronic mail address and a public key corresponding to the electronic mail address, wherein the private key is used when a signature of an electronic mail transmitter is affixed to electronic mail and when received encrypted electronic mail is decrypted and wherein the public key is used when electronic mail is encrypted so that the encrypted electronic mail is read only by a user having an electronic mail address designated as an destination of the electronic mail and when a checking is made on whether electronic mail has been tampered or not, and

a data processing device having:

a mail encrypting unit to read the public key corresponding to the electronic mail address of the destination of the electronic mail from the public key storing unit and to encrypt electronic mail in a form of clear text electronic mail received from the user terminal using the public key;

a mail signature affixing unit to read the private key corresponding to the electronic mail address of the electronic mail transmitter, to calculate a message digest of the encrypted electronic mail and to encrypt a value obtained by the calculation using the private key and to affix the value to the electronic mail as the signature of the mail transmitter;

a mail signature checking unit to read the public key corresponding to the electronic mail address of the electronic mail transmitter from the public key storing unit, to decrypt the signature of the encrypted electronic mail received from the Internet using the public key and to check whether the encrypted electronic mail has been tampered or not by comparing values of the signature with the message digest of the encrypted electronic mail;

a mail decrypting unit to read the private key corresponding to the electronic mail address of the destination of the electronic mail and to decrypt the electronic mail that has been encrypted and has not been tampered using the private key; and

a mail distributing unit to distribute decrypted electronic mail, when a request for receiving electronic mail is made by the user terminal, to the user terminal.

According to a fifth aspect of the present invention, there is provided a security managing method of electronic mail implemented by an internet service provider that provides service to connect a user terminal to the Internet, including:

a step of encrypting electronic mail to be transmitted from the user terminal to the Internet and of affixing a signature to the electronic mail;

a step of checking whether the electronic mail transmitted from the Internet to the user terminal has been tampered or not and of decrypting the electronic mail transmitted from the Internet to the user terminal; and

wherein processing required for security management having above steps is executed for users by the internet service provider disposed at a connecting point with the Internet, which enables assurance of security of electronic mail in the Internet irrespective of types of the user terminal or of whether a security function is implemented on a side of the user terminal or not.

According to a sixth aspect of the present invention, there is provided a security managing method of electronic mail implemented by a server which executes assurance of security for a user terminal in an internet service provider that provides service to connect the user terminal to the Internet, including;

a step of encrypting clear text electronic mail fed from the user terminal so that only an electronic mail receiver is allowed to decrypt the encrypted electronic mail;

a step of affixing a signature of an electronic mail transmitter to the encrypted electronic mail to be transmitted and of transmitting the encrypted electronic mail with the signature to the Internet;

a step of checking, when the encrypted electronic mail with the signature addressed to the user terminal is transmitted to the server through the Internet, whether the encrypted electronic mail has been tampered or not;

a step of decrypting, when the encrypted electronic mail has not been tampered, the encrypted electronic mail to produce clear text electronic mail and then to distribute the produced clear text electronic mail to the user who has made a request for receiving the electronic mail; and

a step of refusing to receive the encrypted electronic mail when the encrypted electronic mail has been tampered.

According to a seventh aspect of the present invention, there is provided a security managing method of electronic mail including:

a step of a user creating electronic mail and transmitting the electronic mail in a form of clear text electronic mail to an internet service provider;

a step of receiving the electronic mail transmitted from the user terminal at the internet service provider, of reading a public key corresponding to an electronic mail address of a destination of the electronic mail from a public key storing unit storing a pair of pieces of information about the electronic mail address and the public key corresponding to the electronic mail address and of encrypting the clear text electronic mail by using the public key;

a step of reading a private key corresponding to the electronic mail address of a transmitter of the electronic mail from a private key storing unit storing a pair of pieces of information about the electronic mail address and the private key corresponding to the electronic mail address, of calculating a message digest of the encrypted electronic mail and encrypting values obtained by the calculation using the private key and affixing the encrypted value to the electronic mail as a signature of the mail transmitter; and

a step of transmitting the encrypted electronic mail with the signatures from the internet service provider to the Internet.

In the forgoing seventh aspect, a preferable mode is one that wherein further includes:

a step of the internet service provider receiving the encrypted electronic mail with the signature from the Internet;

a step of reading the public key corresponding to the electronic mail address of the electronic mail transmitter from the public key storing unit and of decrypting the signature affixed to the encrypted electronic mail using the public key;

a step of checking whether the encrypted electronic mail has been tampered or not by comparing values of the signature with the message digest of the encrypted electronic mail;

a step of reading, when the encrypted electronic mail has not been tampered, the private key corresponding to an electronic mail address of a destination of the electronic mail from the private key storing unit and of decrypting the encrypted electronic mail using the private key; and

a step of distributing, when a request for receiving electronic mail is made by the user terminal, the decrypted electronic mail in a form of clear text electronic mail to the user terminal.

According to an eighth aspect of the present invention, there is provided a storage medium for being used in a server of an internet service provider which provides service to connect a user terminal to the Internet having a private key storing unit used to store a pair of pieces of information about an electronic mail address and a private key corresponding to the electronic mail address and a public key storing unit used to store a pair of pieces of information about the electronic mail address and a public key corresponding to the electronic mail address wherein the private key is used when a signature of a mail transmitter is affixed to the electronic mail and when an encrypted mail transmitted from the Internet is decrypted and wherein the public key is used when the electronic mail is encrypted so that only a user having an electronic mail address designated as a destination of the electronic mail can read the encrypted electronic mail and when a checking is made on whether the electronic mail has been tampered or not, the storage medium storing programs having a computer execute processes having;

(a) mail encryption by reading the public key corresponding to an electronic mail address of a destination of a clear text mail being received from the user terminal from the public key storing unit and by encrypting the clear text electronic mail using the public key;

(b) mail signature affixing by reading the private key corresponding to an electronic mail address of an electronic mail transmitter from the private key storing unit and by calculating a message digest of the electronic mail and by encrypting values obtained by the calculation and affixing the encrypted values to the electronic mail as a signature of a mail transmitter;

(c) mail signature checking by reading the public key corresponding to an electronic mail address of an electronic mail transmitter from the public key storing unit and by decrypting the signature affixed to the encrypted electronic mail transmitted from the Internet using the public key and by checking whether the electronic mail has been tampered or not by comparing the value of the signature with the message digest of the electronic mail;

(d) mail decryption by reading the private key corresponding to an electronic mail address of a destination of the electronic mail from the private key storing unit and by decrypting the encrypted electronic mail using the private key; and

(e) mail distribution by distributing, when a request for receiving electronic mail is made by the user terminal, the decrypted clear text mail to the user terminal.

With the above configurations, the security of the electronic mail on the Internet can be assured without installing special software and/or devices on the user terminal receiving electronic mail. In the internet service provider in which portable cellular phones, personal digital assistant or a like, that are becoming wide spread in recent years, can be used as terminals of mail clients, since types of the terminals that can be used become various and diverse and since the number of units already shipped is enormous, the system and method of the present invention in which security of the electronic mail is managed by using the internet service provider can provide remarkable effects in improving the security of the electronic mail in the Internet. The reason is because, in the present invention, processing required for assuring security of the electronic mail is not performed by the user terminal but is executed for the user by the internet service provider having a connecting point with the Internet and because a threat to security in the network connected in a wired or wireless form between the user terminal and the internet service provider is remarkably less than in the Internet, in general, thus enabling functions of assuring security to be implemented on the point being connected with the Internet.

With another configuration, managing costs required for assuring security in the electronic mail in the Internet can be greatly reduced, that is, for users using a plurality of terminals in particular, cost reduction is very great because there is no need for individually providing security to each of the plurality of terminals. This can be implemented because, the private key, public key or a like required for assuring security is managed in a unified way.

### BRIEF DESCRIPTION OF THE DRAWINGS

The above and other objects, advantages, and features of the present invention will be more apparent from the following description taken in conjunction with the accompanying drawings in which:

FIG. 1 is a diagram showing configurations of a system according to an embodiment of the present invention;

FIG. 2 is a diagram showing one example of configurations of a server of an internet service provider according to the embodiment of the present invention;

FIG. 3 is a flowchart explaining operations at a time of transmitting electronic mail from user terminals performed according to the embodiment of the present invention;

FIG. 4 is a flowchart explaining operations at a time of receiving an encrypted mail with a signature from the Internet performed according to the embodiment of the present invention;

FIG. 5 is a diagram showing examples of a pair of pieces of information about an electronic mail address and a private key stored in a private key storing unit according to the embodiment of the present invention; and

FIG. 6 is a diagram showing examples of a pair of pieces of information about the electronic mail address and a public key stored in a public key storing unit according to the embodiment of the present invention.

### DETAILED DESCRIPTION OF THE PREFERRED EMBODIMENTS

Best modes of carrying out the present invention will be described in further detail using various embodiments with reference to the accompanying drawings.

According to the present invention, an internet service provider (ISP) providing users with functions for electronic mail executes encryption and decryption of electronic mail, affixing of signatures and detection of tampering of electronic mail, thus assuring security of electronic mail in the Internet, instead of users, irrespective of a type of a mail client of a user or irrespective of whether a user terminal is provided with security functions on a mail client side or a user terminal side.

### Embodiment

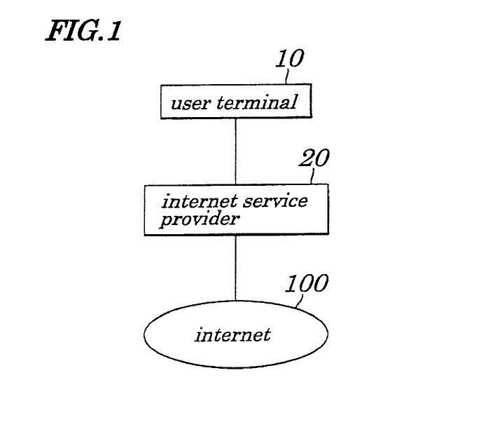

FIG. 1 is a diagram showing configurations of a system according to an embodiment of the present invention. In the embodiment shown in FIG. 1, a user is using service provided by an internet service provider 20 and the user is assigned an electronic mail address by the internet service provider 20. The user is connected to the internet service provider 20 using a user terminal 10 and transmits a clear text mail which has no signature and has not been encrypted to the internet service provider 20.

The internet service provider 20 encrypts the clear text mail to that it can be decrypted only by a mail receiver and transmits the encrypted mail with a signature of the mail transmitter affixed, to the Internet 100 as the encrypted mail with the signature.

The internet service provider 20, when having received the encrypted mail with the signature through the Internet 100, checks if the encrypted mail has been tampered or not.

As a result of the check, the internet service provider 20, if the mail has not been tampered, decrypts the encrypted mail to the clear text mail and stores it.

On the other hand, if the encrypted mail has been tampered, the internet service provider 20 refuses to receive the tampered electronic encrypted mail and prevents it from being transmitted to the user.

The user connects a user terminal to the internet service provider 20 using the user terminal 10 and receives the clear text mail being assured of no tampering of the electronic mail on the Internet 100.

The user terminal 10 is made up of a terminal having a function of connecting the user terminal 10 to the Internet through the internet service provider 20 which includes a portable cellular phone terminal, personal digital assistant terminal, personal computer terminal or a like.

The user terminal 10 has a function of transmitting and receiving electronic mail through the internet service provider 20 and a function of connecting the user terminal 10 to the internet service provider 20 in a wired or wireless manner.

The internet service provider 20 is made up of an information processing device such as a server and is adapted to provide services of transmitting and receiving electronic mail (mail server service) to and from the Internet 100, to users who have been registered in advance.

Only users who have been registered in advance can use a service of transmitting and receiving electronic mail to and from the Internet100 through the internet service provider 20.

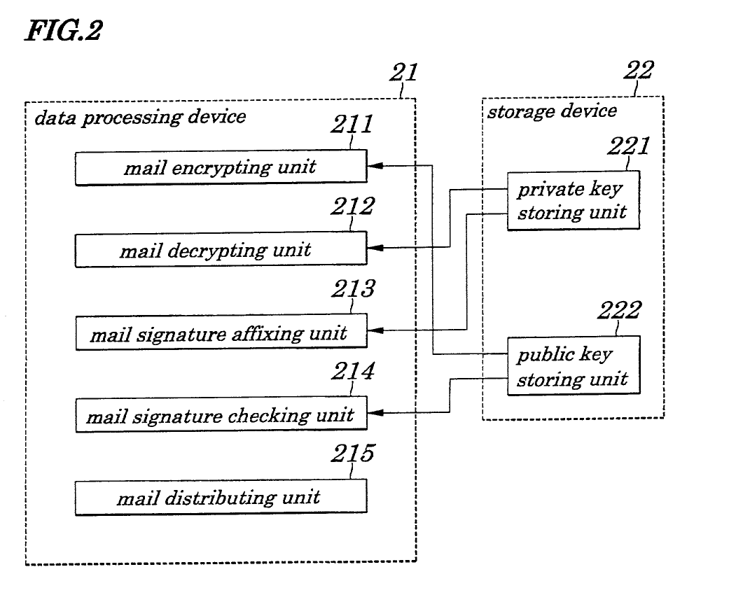

FIG. 2 is a diagram showing one example of configurations of a server of the internet service provider 20 according to the first embodiment of the present invention. As shown in FIG. 2, the server of the internet service provider 20 includes a data processing device 21 and a storage device 22. The internet service provider 20 has functions of generating information used to assign an electronic mail address to a user, to encrypt the electronic mail or to affix a signature to the electronic mail, of storing, in a paired form, information required for assigning the electronic mail address and for encrypting the electronic mail and for affixing the signature to the electronic mail.

As information used to encrypt the electronic mail or to affix the signature to the electronic mail, a private key and a public key are available which are used in a paired form.

The data processing device 21 making up the server of the internet service provider 20 has a mail encrypting unit 211 used to encrypt electronic mail which are transmitted using the user terminal 10 and are not encrypted and do not have a signature so that only a mail receiver already designated as an destination is permitted to read the electronic mail, a mail signature affixing unit 213 used to affix a signature of a transmitter of the electronic mail and to transmit the electronic mail through the Internet 100, a mail signature checking unit 214 used to check whether the electronic mail received from the Internet 100 has been tampered or not, to abandon the electronic mail if it has been tampered and to protect the user against tampered mail, a mail decrypting unit 212 used to decrypt encrypted electronic mail and to store the decrypted mail as a clear text mail and a mail distributing unit 215 used to distribute the decrypted clear text mail to the user terminal 10 when the user wants to receive the electronic mail from the user terminal 10. The storage device 22 of the server of the internet service provider 20 includes a private key storing unit 221 used to store a pair of pieces of information about the electronic mail address and a private key corresponding to the electronic mail address and a public key storing unit 222 used to store a pair of pieces of information about the electronic mail address and a public key corresponding to the electronic mail address. The private key is used by the mail signature affixing unit 213 used to affix a signature of a mail transmitter to the electronic mail and by the mail decrypting unit 212 used to decrypt encrypted mail transmitted and the public key is used by the mail encrypting unit 211 used to encrypt the mail to that only the user having the electronic mail address designated as a destination of the electronic mail is allowed to read the electronic mail and by the mail signature checking unit 214 used to check if the electronic mail has been tampered or not.

Functions of these units 211 to 215 provided to the server of the internet service provider 20 can be implemented when programs to control these units 211 to 215 are executed by the data processing device 21 making up the server. At this point, the server of the internet service provider 20 of the present invention can be operated by reading programs from a storage medium including a magnetic disk, magnetic tape, optical disk, semiconductor memory or a like storing the programs to the data processing device 21 and by executing the programs.

Next, operations of the system and method of the embodiment will be described by referring to FIG. 1 to FIG. 6.

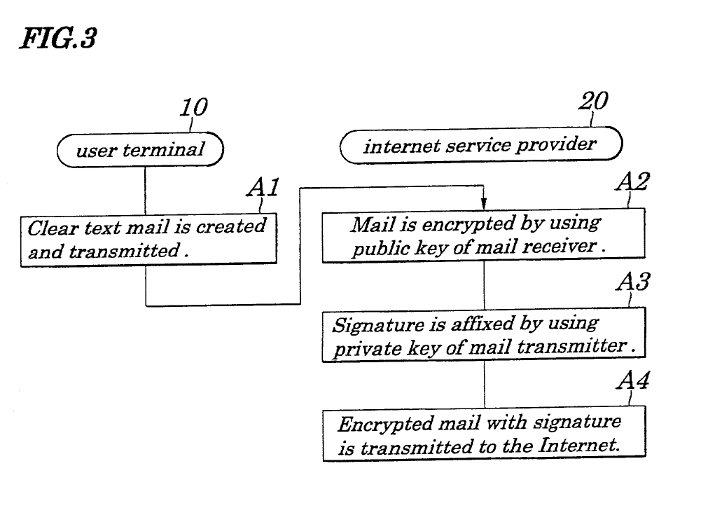

FIG. 3 is a flowchart explaining operations at a time of transmitting electronic mail from user terminal 10 performed according to the embodiment of the present invention. First, operations performed when the electronic mail is transmitted from the user terminal 10 will be described.

The user creates an electronic mail using the user terminal 10 and transmits the created electronic mail in a clear text form to the internet service provider 20 (Step A1).

The internet service provider 20 receives the clear text mail and encrypts the received clear text mail by using the public key corresponding to an electronic mail address of a destination of the mail to be transmitted (Step A2).

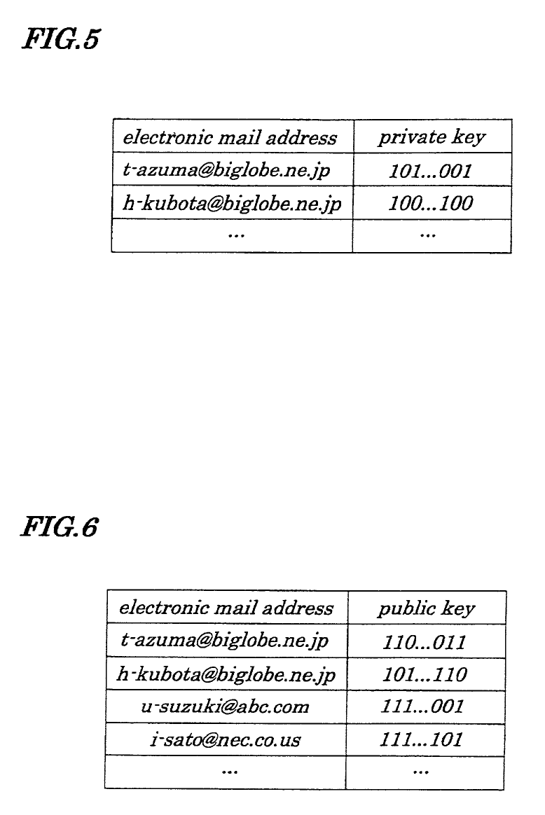

FIG. 6 is a diagram showing examples of a pair of pieces of information about the electronic mail address and the public key stored in the public key storing unit 222 of the internet service provider 20.

If an electronic mail address of an destination of the electronic mail is, for example,

a “111 . . . 001” is used as the public key corresponding to the electronic mail address for encryption.

Then, the internet service provider 20 affixes a signature to the electronic mail using the private key corresponding to the mail address of the mail transmitter (Step A3).

To affix the signature to the electronic mail, a method in which a message digest (that is, a hash value) of the electronic mail is calculated and its calculated value encrypted by using the private key is affixed to the electronic mail is generally used.

FIG. 5 is a diagram showing examples of a pair of pieces of information about an electronic mail address stored in the internet service provider 20 and the private key stored in the private key storing unit 221 of the internet service provider 20 according to the embodiment of the present invention.

If a mail address of a mail transmitter is, for example, “t-azuma@biglobe.ne.jp”, a “101 . . . 001” is used as the private key corresponding to the address for affixing the signature to the electronic mail.

Finally, the internet service provider 20 transmits the encrypted mail with the signature to the Internet 100 (Step A4 in FIG. 3).

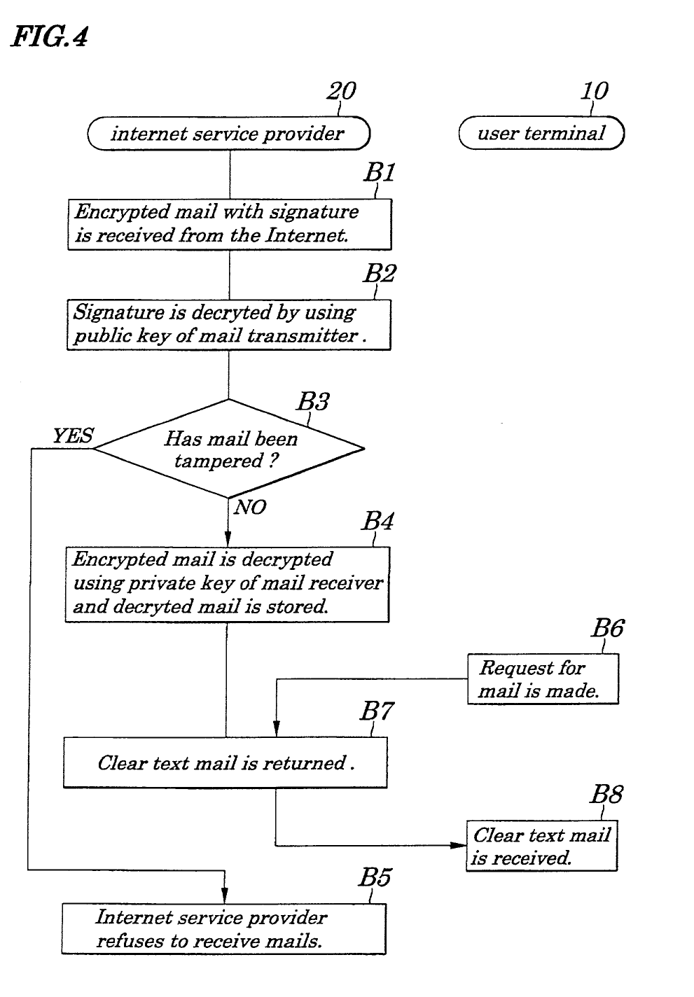

FIG. 4 is a flowchart explaining operations at a time of receiving the encrypted mail with the signature from the Internet 100 performed according to the first embodiment of the present invention. Operations performed when the encrypted mail with the signature is received from the Internet 100 will be described by referring to FIG. 4.

The internet service provider 20 receives the encrypted electronic mail with the signature from the Internet 100 (Step B1).

The internet service provider 20 decrypts the signature affixed to the electronic mail by using the public key corresponding to an electronic mail address of a mail transmitter (Step B2) and checks if the electronic mail has been tampered or not by comparing a value of the signature with the message digest (hash value) of the mail (Step B3).

In the example shown in FIG. 6, if a mail address of the mail transmitter is

, the “111 . . . 001” is used as the corresponding public key for decrypting the signature affixed to the electronic mail. When the electronic mail has not been tampered, the internet service provider 20 decrypts the encrypted electronic mail by using the private key corresponding to the mail address of the destination of the electronic mail and stores the decrypted electronic mail (Step B4).

In the example shown in FIG. 5, if a mail address of the mail receiver is

, the “101 . . . 001” is used as the corresponding private key for decrypting the encrypted message.

When the electronic mail has been tampered, the internet service provider 20 refuses to receive the tampered electronic mail and prevents the tampered electronic mail from reaching the user (Step B5).

The internet service provider 20, when a request for receiving electronic mail is made by the user terminal 10, the clear text mail is returned back to the mail client (Step B7).

The user makes a request for receiving electronic mail which have been received by the internet service provider 20 by using the user terminal 10 (Step B6) and receives the clear text mail from the internet service provider 20 (Step B8).

It is apparent that the present invention is not limited to the above embodiments but may be changed and modified without departing from the scope and spirit of the invention.

What is claimed is:

1. A system executing and assuring security of electronic mail for users, comprising:
an internet service provider that provides service to connect a user terminal to the Internet and executes for said users processing required for security management including encryption of electronic mail to be transmitted from said user terminal to said Internet, affixing of signatures to said electronic mail, checking on tampering of and decryption of said encrypted electronic mail with said signatures transmitted from said Internet.

2. A system executing and assuring security of electronic mail for users, comprising:
an internet service provider that provides service to connect a user terminal to the Internet and that includes,
a means to encrypt electronic mail received from said user terminal, to affix a signature to said electronic mail and to transmit said encrypted electronic mail with said signature to said Internet;
a means to check whether said encrypted electronic mail has been tampered or not when said encrypted electronic mail with said signature is transmitted from said Internet and to decrypt said encrypted electronic mail when said encrypted electronic mail has not been tampered; and
whereby security of electronic mail in said Internet is able to be assured regardless of types of said user terminal or regardless of whether security functions are implemented or not on a side of said user terminal.

3. A system executing and assuring security of electronic mail for users, comprising:
an internet service provider that provides service to connect a user terminal to the Internet and that includes,
a means to encrypt clear text electronic mail received from said user terminal so that only an electronic mail receiver is allowed to decrypt said encrypted electronic mail;
a means to affix a signature of an electronic mail transmitter to said encrypted electronic mail and to transmit said encrypted electronic mail with said signature to said Internet;
a means to check, when said encrypted electronic mail with said signature addressed to said user terminal is received through said Internet, whether said encrypted electronic mail with said signature has been tampered or not;
a means to decrypt said encrypted electronic mail, when said encrypted electronic mail has not been tampered, to produce said clear text electronic mail;
a means to distribute said produced clear text electronic mail to said user terminal when a request for receiving electronic mail is made by said user terminal; and
wherein, if said encrypted electronic mail has been tampered, said encrypted electronic mail is discarded.

4. A server of an internet service provider that provides service to connect a user terminal to the Internet, comprising:
a storage device having a private key storing means to store a pair of pieces of information about an electronic mail address and a private key corresponding to said electronic mail address and a public key storing means to store a pair of pieces of information about an electronic mail address and a public key corresponding to said electronic mail address, wherein said private key is used when a signature of an electronic mail transmitter is affixed to electronic mail and when received encrypted electronic mail is decrypted and wherein said public key is used when electronic mail is encrypted so that said encrypted electronic mail is read only by a user having an electronic mail address designated as an destination of said electronic mail and when a checking is made on whether electronic mail has been tampered or not, and
a data processing device having:
a mail encrypting means to read said public key corresponding to said electronic mail address of said destination of said electronic mail from said public key storing means and to encrypt electronic mail in a form of clear text electronic mail received from said user terminal using said public key;
a mail signature affixing means to read said private key corresponding to said electronic mail address of said electronic mail transmitter, to calculate a message digest of said encrypted electronic mail and to encrypt a value obtained by said calculation using said private key and to affix said value to said electronic mail as said signature of said mail transmitter;
a mail signature checking means to read said public key corresponding to said electronic mail address of said electronic mail transmitter from said public key storing means, to decrypt said signature of said encrypted electronic mail received from said Internet using said public key and to check whether said encrypted electronic mail has been tampered or not by comparing values of said signature with said message digest of said encrypted electronic mail;
a mail decrypting means to read said private key corresponding to said electronic mail address of said destination of said electronic mail and to decrypt said electronic mail that has been encrypted and has not been tampered using said private key; and
a mail distributing means to distribute decrypted electronic mail, when a request for receiving electronic mail is made by said user terminal, to said user terminal.

5. A security managing method of electronic mail implemented by an internet service provider that provides service to connect a user terminal to the Internet, comprising:
a step of encrypting electronic mail to be transmitted from said user terminal to said Internet and of affixing a signature to said electronic mail;
a step of checking whether said electronic mail transmitted from said Internet to said user terminal has been tampered or not and of decrypting said electronic mail transmitted from said Internet to said user terminal; and
wherein processing required for security management including above steps is executed f or users by said internet service provider disposed at a connecting point with said Internet, which enables assurance of security of electronic mail in said Internet irrespective of types of said user terminal or of whether a security function is implemented on a side of said user terminal or not.

6. A security managing method of electronic mail implemented by a server which executes assurance of security for a user terminal in an internet service provider that provides service to connect said user terminal to the Internet, comprising;
a step of encrypting clear text electronic mail fed from said user terminal so that only an electronic mail receiver is allowed to decrypt said encrypted electronic mail;
a step of affixing a signature of an electronic mail transmitter to said encrypted electronic mail to be transmitted and of transmitting said encrypted electronic mail with said signature to said Internet;
a step of checking, when said encrypted electronic mail with said signature addressed to said user terminal is transmitted to said server through said Internet, whether said encrypted electronic mail has been tampered or not;
a step of decrypting, when said encrypted electronic mail has not been tampered, said encrypted electronic mail to produce clear text electronic mail and then to distribute said produced clear text electronic mail to said user who has made a request for receiving said electronic mail; and
a step of refusing to receive said encrypted electronic mail when said encrypted electronic mail has been tampered.

7. A security managing method of electronic mail comprising:
a step of a user creating electronic mail and transmitting said electronic mail in a form of clear text electronic mail to an internet service provider;
a step of receiving said electronic mail transmitted from said user terminal at said internet service provider, of reading a public key corresponding to an electronic mail address of a destination of said electronic mail from a public key storing means storing a pair of pieces of information about said electronic mail address and said public key corresponding to said electronic mail address and of encrypting said clear text electronic mail by using said public key;
a step of reading a private key corresponding to said electronic mail address of a transmitter of said electronic mail from a private key storing means storing a pair of pieces of information about said electronic mail address and said private key corresponding to said electronic mail address, of calculating a message digest of said encrypted electronic mail and encrypting values obtained by said calculation using said private key and affixing said encrypted value to said electronic mail as a signature of said mail transmitter; and
a step of transmitting said encrypted electronic mail with said signatures from said internet service provider to said Internet.

8. The security managing method of electronic mail according to claim 7, further comprising:
a step of said internet service provider receiving said encrypted electronic mail with said signature from said Internet;
a step of reading said public key corresponding to said electronic mail address of said electronic mail transmitter from said public key storing means and of decrypting said signature affixed to said encrypted electronic mail using said public key;
a step of checking whether said encrypted electronic mail has been tampered or not by comparing values of said signature with said message digest of said encrypted electronic mail;
a step of reading, when said encrypted electronic mail has not been tampered, said private key corresponding to an electronic mail address of a destination of said electronic mail from said private key storing means and of decrypting said encrypted electronic mail using said private key; and
a step of distributing, when a request for receiving electronic mail is made by said user terminal, said decrypted electronic mail in a form of clear text electronic mail to said user terminal.

9. A storage medium for being used in a server of an internet service provider which provides service to connect a user terminal to the Internet having a private key storing means used to store a pair of pieces of information about an electronic mail address and a private key corresponding to said electronic mail address and a public key storing means used to store a pair of pieces of information about said electronic mail address and a public key corresponding to said electronic mail address wherein said private key is used when a signature of a mail transmitter is affixed to said electronic mail and when an encrypted mail transmitted from said Internet is decrypted and wherein said public key is used when said electronic mail is encrypted so that only a user having an electronic mail address designated as a destination of said electronic mail can read said encrypted electronic mail and when a checking is made on whether said electronic mail has been tampered or not, said storage medium storing programs having a computer execute processes including;
(a) mail encryption by reading said public key corresponding to an electronic mail address of a destination of a clear text mail being received from said user terminal from said public key storing means and by encrypting said clear text electronic mail using said public key;
(b) mail signature affixing by reading said private key corresponding to an electronic mail address of an electronic mail transmitter from said private key storing means and by calculating a message digest of said electronic mail and by encrypting values obtained by said calculation and affixing said encrypted values to said electronic mail as a signature of a mail transmitter;
(c) mail signature checking by reading said public key corresponding to an electronic mail address of an electronic mail transmitter from said public key storing means and by decrypting said signature affixed to said encrypted electronic mail transmitted from said Internet using said public key and by checking whether said electronic mail has been tampered or not by comparing said value of said signature with said message digest of said electronic mail;
(d) mail decryption by reading said private key corresponding to an electronic mail address of a destination of said electronic mail from said private key storing means and by decrypting said encrypted electronic mail using said private key; and
(e) mail distribution by distributing, when a request for receiving electronic mail is made by said user terminal, said decrypted clear text mail to said user terminal.
